(19) United States
(12) Patent Application Publication
(10) Pub. No.: US 2025/0196907 A1
(43) Pub. Date: Jun. 19, 2025

(54) Baby Stroller Frame with Simple Structure

(71) Applicant: SUNNYLOVE BABY PRODUCTS ZHUHAI CO., LTD, Zhuhai City (CN)

(72) Inventors: XIU PING LIU, Zhuhai City (CN); JIN HUA ZHOU, Zhuhai City (CN)

(21) Appl. No.: 18/976,339

(22) Filed: Dec. 11, 2024

(30) Foreign Application Priority Data
Dec. 14, 2023 (CN) 202323426656.3

(51) Int. Cl. B62B 7/06; B62B 9/20

(52) U.S. Cl. CPC B62B 7/064; B62B 9/20; B62B 2205/20

(57) ABSTRACT

A baby stroller frame includes a base frame and a push rod assembly. A lower end of the pushrod assembly is rotatably connected to the base frame. A support linkage element is positioned between the pushrod assembly and the base frame, with its upper end rotatably connected to the pushrod assembly and its lower end slidably and rotatably connected to the base frame via a connecting assembly. The baby stroller frame also includes a locking mechanism for securing the lower end of the support linkage element with respect to the base frame when the baby stroller frame is in its unfolded state. A linkage unlocking assembly is provided to unlock the locking mechanism.

### CROSS REFERENCE OF RELATED APPLICATION

This application is a non-provisional application that claims priority under 35U.S.C. § 119 to China application number CN202323426656.3, filing date Dec. 14, 2023, wherein the entire content of which is expressly incorporated herein by reference.

### BACKGROUND OF THE PRESENT INVENTION

### Field of Invention

The present invention relates to the technical field of baby stroller, and more particular to a baby stroller with simple structure.

### Description of Related Arts

Currently, a folding mechanism of a stroller frame on the market typically use either multi-link or multi-segment structures, both of which are relatively costly to manufacture. If a multi-link folding mechanism is used, it tends to be structurally complex, cumbersome to operate, and inconvenient to use. On the other hand, if a multi-segment folding mechanism is employed, each joint requires a locking device. Folding such a mechanism necessitates unlocking multiple locking devices, making the operation highly cumbersome and inconvenient for users.

### SUMMARY OF THE PRESENT INVENTION

The invention aims to overcome the shortcomings of the conventional technology by providing a structurally simple baby stroller frame. It features easy operation, convenient folding and unfolding, and a compact overall volume after folding, effectively reducing manufacturing costs and enhancing product competitiveness.

This present invention provides a structurally simple baby stroller frame, which can switch between an unfolded state and a folded state. The baby stroller frame comprises a base frame and a push rod assembly. The base frame is equipped with a front wheel assembly and a rear wheel assembly. A lower end of the pushrod assembly is rotatably connected to a front end of the base frame. A support linkage element is positioned between the pushrod assembly and the base frame, with its upper end rotatably connected to a middle section of the pushrod assembly and its lower end slidably and rotatably connected to a middle section of the base frame via a connecting assembly. The baby stroller frame also comprises a locking mechanism for securing the lower end of the support linkage element with respect to the base frame when the baby stroller frame is in its unfolded state. Additionally, the baby stroller frame is provided with a linkage unlocking assembly to engage and unlock the locking mechanism.

In the described structurally simple baby stroller frame, the connecting assembly has a connection sliding groove arranged on the base frame and extending along a longitudinal direction of the base frame, and comprises a connection pin that is slidably and rotatably positioned within the connection sliding groove. The connection pin is connected and fixed to the lower end of the support linkage element.

In the unfolded state of the baby stroller frame, the connection pin fits against a corresponding inner end of the connection sliding groove. In the folded state of the frame, the connection pin fits against another inner end of the connection sliding groove.

The connecting assembly comprises a sliding sleeve mounted on the base frame and capable of sliding along the longitudinal direction of the base frame. The sliding sleeve is rotatably connected to the lower end of the support linkage element, and the locking mechanism is used to lock the sliding sleeve onto the base frame.

The locking mechanism is configured to lock the connection pin with respect to the base frame when the baby stroller frame is in the unfolded use state.

The locking mechanism comprises a frame locking part whose end is rotatably connected to the base frame. The frame locking part is provided with a locking catch notch that engages with the connection pin when the baby stroller frame is in the unfolded state, thereby locking the connection pin with respect to the base frame. A reset elastic element is arranged between the frame locking part and the base frame to elastically maintain the locking catch notch in engagement with the connection pin.

The linkage unlocking assembly comprises an unlocking handle movably installed on the push rod assembly. The unlocking handle is connected to the frame locking part via an unlocking rope.

The push rod assembly comprises a lower pushrod and an upper pushrod that are slidably sleeved together. The lower end of the lower push rod is rotatably connected to the front end of the base frame. An upper push rod locking mechanism is provided between the upper pushrod and the lower pushrod to lock the upper pushrod with respect to the lower pushrod. The linkage unlocking assembly is configured to be triggered by the upper pushrod when it retracts to a preset length with respect to the lower pushrod, thereby unlocking the locking mechanism.

According to an embodiment, two support linkage elements are connected by a connecting crossbar.

According to an embodiment, the support linkage element is a telescopically adjustable pneumatic spring support rod.

Compared with the conventional technology, this present invention has the following advantages.

The structure is simple, with fewer components. A single set of locking mechanisms suffices to lock the lower end of the support linkage element with respect to the base frame, securing the entire frame in the unfolded state. Similarly, a single linkage unlocking assembly is sufficient to unlock the locking mechanism, enabling easy operation for folding or unfolding. The folded structure is relatively flat and compact, making it convenient to carry and store while reducing manufacturing costs and enhancing product competitiveness.

The connection between the two support linkage elements through the crossbar enhances the structural strength and stability of the frame, ensuring safe and reliable use.

The support linkage element can be a telescopically adjustable pneumatic spring support rod which provides vibration damping, offering a comfortable riding environment for the occupant. Additionally, the pneumatic spring support rod allows adjustment of the inclination angle of the push rod assembly with respect to the base frame, enabling seat angle adjustment functionality.

Additional advantages and features of the invention will become apparent from the description which follows, and may be realized by means of the instrumentalities and combinations particularly pointing out in the appended claims.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a baby stroller frame in an unfolded state according to a preferred embodiment of the present invention.

FIG. 2 is a side view of the baby stroller frame in the unfolded state according to the above preferred embodiment of the present invention.

FIG. 3 is a schematic view of a locking mechanism of the baby stroller frame in a locked state according to the above preferred embodiment of the present invention.

FIG. 4 is a schematic view of a locking mechanism of the baby stroller frame in an unlocked state according to the above preferred embodiment of the present invention.

FIG. 5 is a side view of the baby stroller frame in an folded state according to the above preferred embodiment of the present invention.

FIG. 6 is a perspective view of the baby stroller frame in the folded state according to the above preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

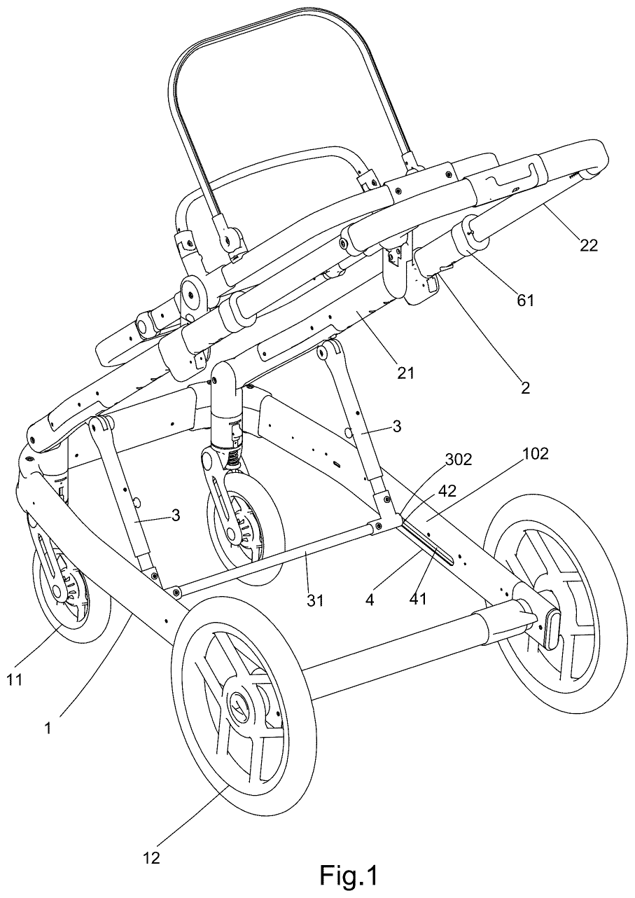

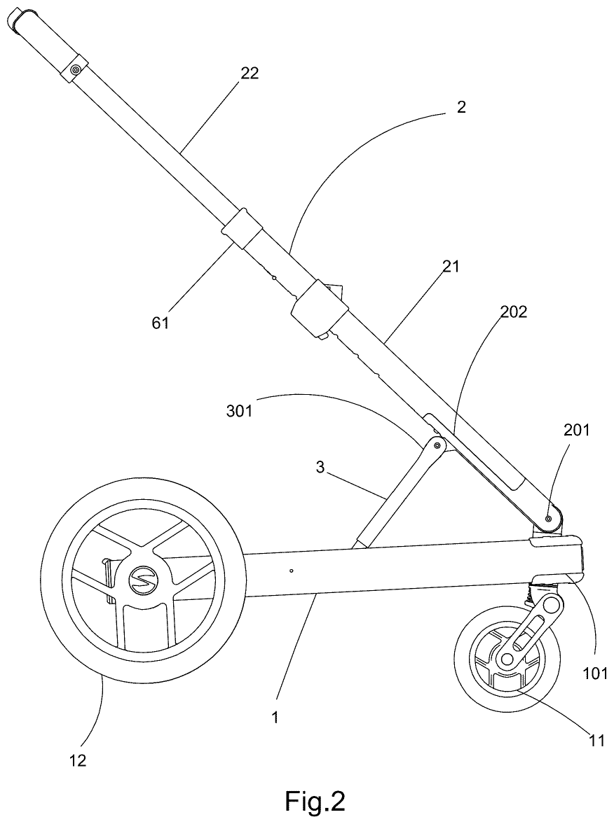

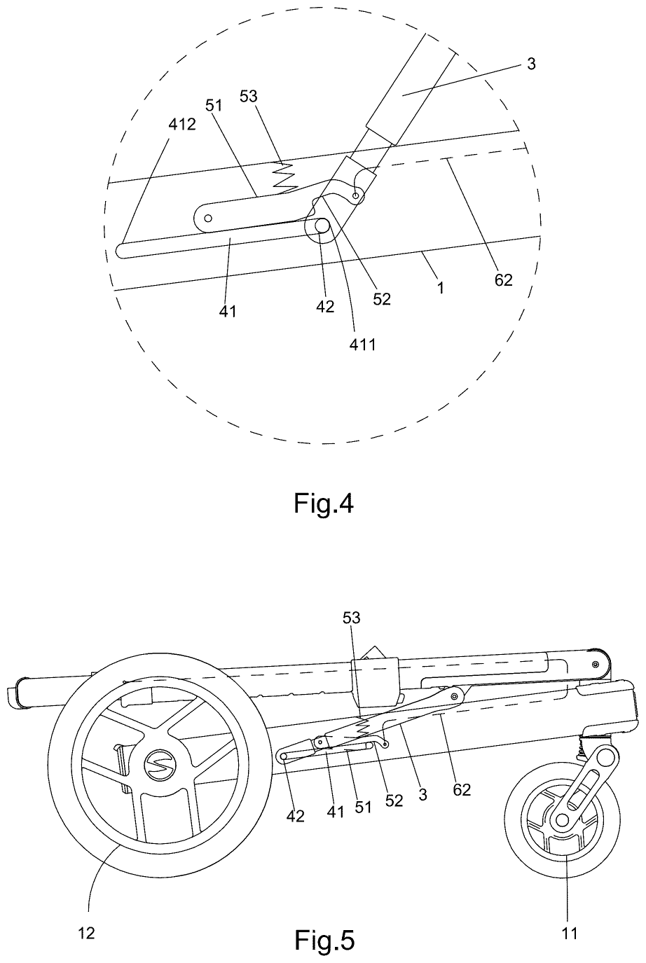

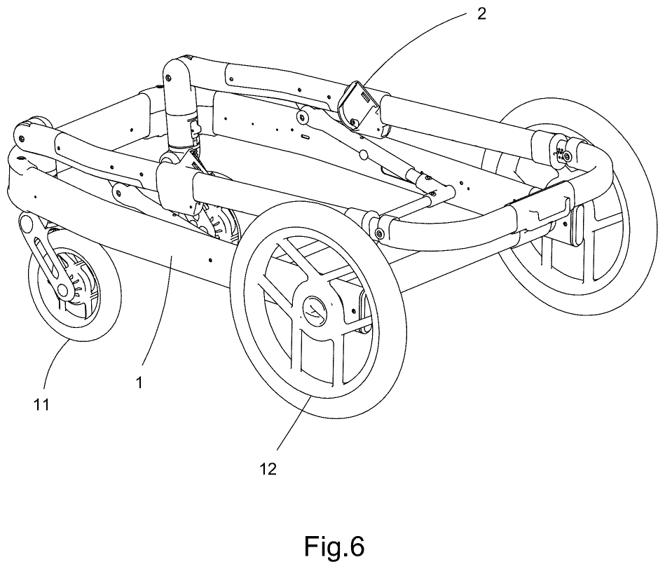

Referring to FIGS. 1 to 6, a baby stroller frame with simple structure according to a preferred embodiment of the present invention is illustrated, the baby stroller frame, which is capable of switching between an unfolded state and a folded state, comprises a base frame 1 and a pushrod assembly 2. The base frame 1 is equipped with a front wheel assembly 11 and a rear wheel assembly 12. A lower end 201 of the pushrod assembly 2 is rotatably connected to a front end 101 of the base frame 1. A support linkage element 3 is positioned between the pushrod assembly 2 and the base frame 1, with its upper end 301 rotatably connected to a middle section 202 of the pushrod assembly 2 and its lower end 302 slidably and rotatably connected to a middle section 102 of the base frame 1 via a connecting assembly 4. The baby stroller frame also comprises a locking mechanism 5 for securing the lower end 302 of the support linkage element 3 with respect to the base frame 1 when the baby stroller frame is in its unfolded state. Additionally, the baby stroller frame is provided with a linkage unlocking assembly 6 to engage and unlock the locking mechanism 5. When folding the baby stroller frame, the user simply operates the linkage unlocking assembly 6 to disengage the locking mechanism 5 from the lower end 302 of the support linkage element 3. At this state, the pushrod assembly 2 can automatically rotate downward around a rotation axis between its lower end 201 and the front end 101 of the base frame 1 until the pushrod assembly 2 aligns closely with the base frame 1. During the folding process, the pushrod assembly 2 drives the lower end 302 of the support linkage element 3 to slide and rotate with respect to the base frame 1, thereby folding the support linkage element 3 between the base frame 1 and the pushrod assembly 2, as shown in FIGS. 5 and 6. This present invention allows the entire baby stroller frame to fold automatically with a simple manual operation of the linkage unlocking assembly 6 to disengage the locking mechanism 5, offering easy operation and user convenience.

The present invention is characterized by a simple structure with fewer components, facilitating easy folding and unfolding. Furthermore, the overall structure becomes flat and compact after folding, making it convenient to carry and store. This design effectively reduces manufacturing costs and enhances market competitiveness.

As shown in FIG. 1, in this embodiment, two locking mechanisms 5 and two linkage unlocking assemblies 6 are respectively arranged and are symmetrically positioned on the base frame 1. During unlocking, the user must simultaneously operate both linkage unlocking assemblies 6 to disengage the corresponding locking mechanisms 5 and release the lower end 302 of the support linkage element 3 from its locked state with respect to the base frame 1. If the user operates only one set of linkage unlocking assemblies 6 to disengage the corresponding frame locking mechanism 5, the lower end of the support linkage element 3 remains partially locked with respect to the base frame 1. This design enhances safety, reliability, and prevents accidental operations.

Preferably, the support linkage element 3 is a telescopically adjustable pneumatic spring support rod. On one hand, during movement, it can reduce the impact of external factors on the seating section mounted on the pushrod assembly 2, such as minimizing vibrations caused by external factors, thereby providing a comfortable riding experience for the occupant. On the other hand, the length of the pneumatic spring support rod can be adjusted to modify the tilt angle of the pushrod assembly 2 with respect to the base frame 1, so as to enable adjustments to the angle of a baby seat on the pushrod assembly 2 of the baby stroller frame.

As shown in FIGS. 1 and 3-5, for convenient connection, the connecting assembly 4 has a connection sliding groove 41 positioned on the base frame 1 and extending along the longitudinal direction of the base frame 1, and comprises a connection pin 42 that is slidably and rotatably placed within the connection sliding groove 41. The connection pin 42 is connected and fixed to the lower end 302 of the support linkage element 3. The guiding cooperation between the connection pin 42 and the connection sliding groove 41 ensures that the lower end of the support linkage element 3 moves along a predetermined path, facilitating stable and smooth folding or unfolding of the stroller frame. Alternatively, the lower end 302 of the support linkage element 3 is pivotally rotatably coupled to the connection pin 42, and the connection pin 42 is only required to be slidably within the connection sliding groove 41.

As shown in FIGS. 1, 3, and 4, when the frame is in the unfolded state, the connection pin 42 is in contact with an inner end of the connection sliding groove 41 which is a front end 411 of the connection sliding groove 41, which helps enhance the structural strength and stability of the baby stroller frame, ensuring safety and reliability during use. Additionally, by inspecting whether the connection pin 42 is in contact with the inner end of the connection sliding groove 41, it is easy to verify whether the baby stroller frame is fully unfolded.

As shown in FIG. 5, when the baby stroller frame is in the folded state, the connection pin 42 is in contact with an opposite inner end of the connection sliding groove 41 which is a rear end 412 of the connection sliding groove 41. By checking whether the connection pin 42 is in contact with this opposite inner end of the connection sliding groove 41, it is easy to verify whether the baby stroller frame is fully folded.

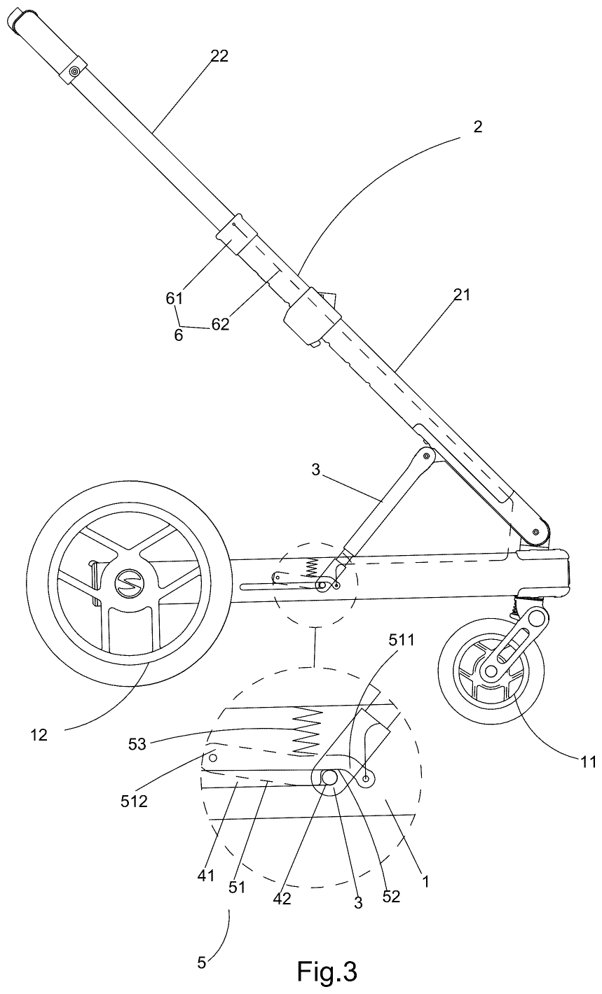

As shown in FIG. 3, in order to securely lock the frame, the frame locking mechanism 5 is designed to lock the connection pin 42 with respect to the base frame 1 when the baby stroller frame is in the unfolded state for usage.

As shown in FIGS. 3-5, for convenience in locking, each locking mechanism 5 comprises a frame locking part 51 that is rotatably connected to the base frame 1 at one end thereof. The frame locking part 51 has a locking catch notch 52 designed to engage with the connection pin 42 when the baby stroller frame is in the unfolded state, thereby locking the connection pin 42 with respect to the base frame 1. A reset elastic element 53 is arranged between the frame locking part 51 and the base frame 1 to keep the locking catch notch 52 in an elastic engagement with the connection pin 42. The reset elastic element 53 can be a compression spring or a torsion spring. If a compression spring is used, it is positioned near the locking catch notch 52, and both ends of the compression spring apply elastic force on the frame locking part 51 and the base frame 1. If a torsion spring is used, it is mounted on the pivot between the frame locking part 51 and the base frame 1, with one end of the spring engaged on the frame locking part 51 and the other end engaged on the base frame 1.

As shown in FIG. 3, for ease of unlocking, each linkage unlocking assembly 6 comprises an unlocking handle 61 that is movably mounted on the pushrod assembly 2. The unlocking handle 61 is connected to the frame locking part 51 via an unlocking rope 62. The unlocking rope 62, which can be embodied as a steel wire rope, is provided to extend within the pushrod assembly 2 and the base frame 1. In this embodiment, the frame locking part 51 has a hinged end 511 and a connecting end 512, the hinged end 511 is connected to the base frame 1 and the connecting end 512 is connected to the unlocking handle 61. The locking catch notch 52 is positioned near the connecting end 512 of the frame locking part 51. During unlocking, the user operates the unlocking handle 61 with respect to the pushrod assembly 2. The unlocking handle 61 drives the unlocking rope 62 to move to cause the frame locking part 51 to rotate upward about its hinged axis, so as to disengage the locking catch notch 52 from the connection pin 42 and releasing the lock between the connection pin 42 and the base frame 1. Furthermore, the reset elastic element 53 located between the connecting end of the frame locking part 51 and the base frame 1 helps reset the frame locking part 51 after rotation.

To provide an alternative mode for the connecting assembly 4, the connecting assembly 4 comprises a connecting sleeve that is mounted on the base frame 1 and can slide along the longitudinal direction of the base frame 1. The connecting sleeve is rotatably connected to the lower end of the support linkage element 3, and the frame locking mechanism 5 is used to lock the connecting sleeve to the base frame 1.

As shown in FIGS. 1-3, for ease of pushing and unlocking, the pushrod assembly 2 comprises a lower pushrod 21 and an upper pushrod 22 that is sleeved with the lower pushrod 21 and are slidably connected with each other. The lower pushrod 21 is rotatably connected to the front end 101 of the base frame 1, and an upper pushrod locking mechanism is positioned between the lower pushrod 21 and the upper pushrod 22 to lock the upper pushrod 22 with respect to the lower pushrod 21. The linkage unlocking assembly 6 is configured to trigger the unlocking mechanism of the frame locking mechanism 5 when the upper pushrod 22 is retracted to a preset length with respect to the lower pushrod 21. In some embodiments, the upper pushrod locking mechanism comprises multiple adjustment lock holes spaced along the length of the lower pushrod 21 and an adjustable locking pin that is movably mounted on the upper pushrod and elastically inserts into the corresponding adjustment lock hole.

As shown in FIG. 1, two support linkage members 3 are connected by a transverse connecting crossbar 31, which helps improve the structural strength and stability of the baby stroller frame, ensuring safety and reliability during use.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and are subject to change without departure from such principles. Therefore, this invention includes all modifications encompassed within the spirit and scope of the following claims.

What is claimed is:

1. A baby stroller frame, which is capable of switching between an unfolded state and a folded state, comprising:
a base frame;
a front wheel assembly connected to said base frame;
a rear wheel assembly connected to said base frame;
a pushrod assembly, wherein a lower end of said pushrod assembly is rotatably connected to a front end of said base frame;
a connecting assembly;
a support linkage element positioned between said pushrod assembly and said base frame, wherein said support linksage element comprises an upper end which is rotatably connected to said pushrod assembly and a lower end which is slidably and rotatabl connected to said base frame via said connecting assembly;
a locking mechanism for retaining said lower end of said support linkage element with respect to said base frame when the baby stroller frame is in said unfolded state; and
a linkage unlocking assembly connected to said pushrod assembly and operatively coupled to said locking mechanism for being operated to unlock said locking mechanism.

2. The baby stroller frame, as recited in claim 1, wherein said connecting assembly has a connection sliding groove arranged on said base frame and extending along a longitudinal direction of said base frame, and comprises a connection pin that is slidably and rotatably positioned within said connection sliding groove, wherein said connection pin is connected and fixed to said lower end of said support linkage element.

3. The baby stroller frame, as recited in claim 2, wherein said connection pin fits against a front end of said connection sliding groove when the baby stroller frame is in said unfolded state and fits against a rear end of said connection sliding groove when the baby stroller frame is in said folded state.

4. The baby stroller frame, as recited in claim 2, wherein said locking mechanism is configured to lock said connection pin with respect to said base frame when the baby stroller frame is in said unfolded use state.

5. The baby stroller frame, as recited in claim 3, wherein said locking mechanism is configured to lock said connection pin with respect to said base frame when the baby stroller frame is in said unfolded use state.

6. The baby stroller frame, as recited in claim 4, wherein said locking mechanism comprises a frame locking part which is rotatably connected to said base frame, wherein said frame locking part has a locking catch notch that engages with said connection pin when the baby stroller frame is in said unfolded state, thereby locking said connection pin with respect to said base frame, wherein said locking mechanism further comprises a reset elastic element which is arranged between said frame locking part and said base frame to elastically maintain said locking catch notch in engagement with said connection pin.

7. The baby stroller frame, as recited in claim 5, wherein said locking mechanism comprises a frame locking part which is rotatably connected to said base frame, wherein said frame locking part has a locking catch notch that engages with said connection pin when the baby stroller frame is in said unfolded state, thereby locking said connection pin with respect to said base frame, wherein said locking mechanism further comprises a reset elastic element which is arranged between said frame locking part and said base frame to elastically maintain said locking catch notch in engagement with said connection pin.

8. The baby stroller frame, as recited in claim 6, wherein said linkage unlocking assembly comprises an unlocking handle movably installed on said push rod assembly and an unlocking rope connecting said unlocking handle to said frame locking part.

9. The baby stroller frame, as recited in claim 7, wherein said linkage unlocking assembly comprises an unlocking handle movably installed on said push rod assembly and an unlocking rope connecting said unlocking handle to said frame locking part.

10. The baby stroller frame, as recited in claim 1, wherein said push rod assembly comprises a lower pushrod and an upper pushrod that are slidably sleeved together.

11. The baby stroller frame, as recited in claim 2, wherein said push rod assembly comprises a lower pushrod and an upper pushrod that are slidably sleeved together.

12. The baby stroller frame, as recited in claim 6, wherein said push rod assembly comprises a lower pushrod and an upper pushrod that are slidably sleeved together.

13. The baby stroller frame, as recited in claim 8, wherein said push rod assembly comprises a lower pushrod and an upper pushrod that are slidably sleeved together.

14. The baby stroller frame, as recited in claim 1, wherein the baby stroller frame comprises two said support linkage elements and a connecting crossbar connected between said two said support linkage element.

15. The baby stroller frame, as recited in claim 6, wherein the baby stroller frame comprises two said support linkage elements and a connecting crossbar connected between said two said support linkage element.

16. The baby stroller frame, as recited in claim 8, wherein the baby stroller frame comprises two said support linkage elements and a connecting crossbar connected between said two said support linkage element.

17. The baby stroller frame, as recited in claim 1, wherein said support linkage element is a telescopically adjustable pneumatic spring support rod.

18. The baby stroller frame, as recited in claim 1, wherein the baby stroller frame comprises two said locking mechanisms and two said linkage unlocking assemblies which are respectively arranged and are symmetrically positioned on said base frame.

19. The baby stroller frame, as recited in claim 6, wherein the baby stroller frame comprises two said locking mechanisms and two said linkage unlocking assemblies which are respectively arranged and are symmetrically positioned on said base frame.

20. The baby stroller frame, as recited in claim 8, wherein the baby stroller frame comprises two said locking mechanisms and two said linkage unlocking assemblies which are respectively arranged and are symmetrically positioned on said base frame.
